(19) United States
(12) Patent Application Publication
(10) Pub. No.: US 2025/0104173 A1
(43) Pub. Date: Mar. 27, 2025

(54) Weighted Vote Donation Pool System For Politicians

(71) Applicant: Jacob Zachary Barnette, Riverview, FL (US)

(72) Inventor: Jacob Zachary Barnette, Riverview, FL (US)

(73) Assignee: Jacob Zachary Barnette, Riverview, FL (US)

(21) Appl. No.: 18/401,604

(22) Filed: Dec. 31, 2023

Related U.S. Application Data
(60) Provisional application No. 63/629,136, filed on Sep. 22, 2023.

(51) Int. Cl. G06Q 50/26; G07C 13/00

(52) U.S. Cl. CPC G06Q 50/26; G07C 13/00

(57) ABSTRACT

The core feature of the invention is a platform where users can create posts explicitly representing desired government initiatives such as law, policy, tax & budget changes in which each post functions as an individual donation pool with a weighted voting system. Users vote on post solutions using a weighted vote scheme where every $1 donated or an upvote equals one voting point. Politicians can submit solutions, either individually or as a team, to posts and receive the payout if their solution is voted as the winner. The winner is determined by a voting period that begins when the first solution submission happens and lasts for 30 days. To win, a solution must receive 51% of the points if there is only one option, or points return until there's a new solution submission. In case of multiple solutions, the one with the highest points wins.

### TECHNICAL FIELD AND PROBLEM SOLVED

The invention falls within the realm of civic engagement technology, specifically addressing the problem of limited citizen influence in the political decision-making process.

### DESCRIPTION

The core feature of the invention is a platform where users can create posts explicitly representing desired government initiatives such as law, policy, tax & budget changes in which each post functions as an individual donation pool with a weighted voting system. Users vote on post solutions using a weighted vote scheme where every $1 donated or an upvote equals one voting point. Politicians can submit solutions (such as text or video files of legislation proposals), either individually or as a team, to posts and receive (a majority of) the payout (amount donated to the particular post) if their solution is voted as the winner. A much smaller but equal percentage of the donation pool goes to the post creator & the platform upon completion. The winner is determined by a voting period that begins when the first solution submission happens and lasts for 30 days. To win, a solution must receive 51% of the points if there is only one option, or points return until there's a new solution submission. In case of multiple solutions, the one with the highest points wins. Additionally, there's a ‘non-satisfactory’ option with every voting period that if wins returns voting points until they can be reused in the next voting period. Lastly, based on a minimum donation threshold per post, users can combine their posts (& thus donation pools) about the same topic to amplify the outreach. In this case, upon completion the post creators split the predetermined percentage that goes towards post creators equally for everything donated while their post is combined.

### ADVANTAGES AND BENEFITS

The invention allows citizens to actively participate in the political process by proposing, supporting, and voting on initiatives. It shifts the focus from campaign fundraising to actionable change by enabling citizens to have a voice in government decisions. This process allows a platform for civic engagement and the possibility to facilitate positive change within the government.

### CONCLUSION

The Weighted Vote Donation Pool System mechanism is a progressive civic engagement dynamic to empower citizens to propose and influence government initiatives. It addresses the problem of limited citizen influence in the political process, providing a solution that benefits both citizens and politicians.

### IMAGE

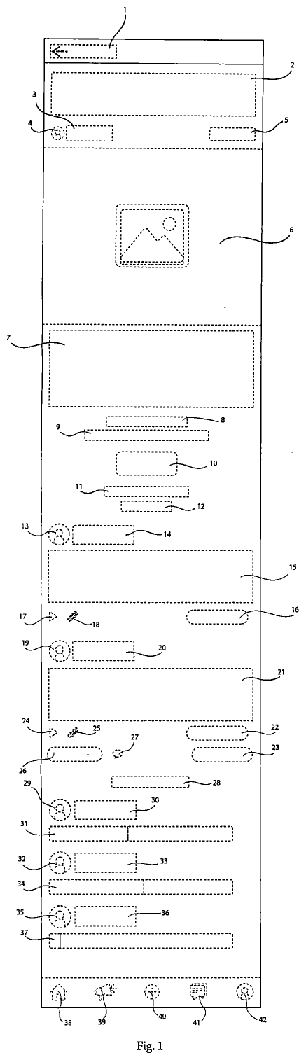

FIG. 1: Post Interaction View—Solution Voting
1. Back button
2. Post title
3. Post creators name
4. Post creators profile picture
5. Vote point tally the user viewing the post possesses for that particular post
6. Post images
7. Post expanded description
8. Total vote point tally
9. Total purchased vote point tally
10. ‘Buy Vote’ button: This allows citizen users to purchase a vote point for $1 each
11. Header saying ‘Solutions Submitted’
12. Days left in the voting period tally
13. Example post 1 politician user profile picture
14. Example post 1 politician user name
15. Example post 1 politician solution description
16. Example post 1 vote button—To apply vote points
17. Example post 1 play media button
18. Example post 1 view file button
19. Example post 2 politician user profile picture
20. Example post 2 politician user name
21. Example post 2 politician solution description
22. Example post 2 vote button-To apply vote points
23. ‘Submit Solution’ button-explicit for politician accounts
24. Example post 2 play media button
25. Example post 2 view file button
26. Upvote button—Allows 1 vote point for citizen users to allocate as they wish
27. Comment button
28. Header saying ‘Last Vote Results’
29. Example post 3 politician user profile picture
30. Example post 3 politician user name
31. Example post 3 bar graph representing percentage of vote points accrued
32. Example post 4 politician user profile picture
33. Example post 4 politician user name
34. Example post 4 bar graph representing percentage of vote points accrued
35. Example post 5 politician user profile picture
36. Example post 5 politician user name
37. Example post 5 bar graph representing percentage of vote points accrued
38. Home button—This displays the feed of all of the initiative proposal posts
39. Debate button—This is for discussions
40. Post button
41. Notification button
42. Account button

1. Establishing a platform that:
a. Provides a user interface for:
i. Creating posts representing desired government initiatives, each including a detailed description and discussion forum. ii. Viewing solution proposals submitted by politicians for posted initiatives. iii. Donating or upvoting solution proposals through two distinct mechanisms:
(A) Monetary contributions: Each dollar donated to a specific initiative translates to one voting point.
(B) Upvotes: Each upvote cast on a solution proposal translates to one voting point.
b. Implements a weighted voting system where each vote is proportional to the sum of:
i. The number of voting points accrued through monetary contributions.
ii. The number of voting points accrued through upvotes.

2. Enabling politicians to submit solution proposals (text, video, or policy documents) to posted initiatives.

3. Automatically initiating a 30-day voting period upon the first solution proposal submission for each initiative.

4. Calculating the winning solution at the end of the voting period as the one with the highest total weighted votes, as determined by the sum of voting points from monetary contributions and upvotes as defined in subsection (b) above.

5. Distributing the total donation pool of a winning initiative according to predetermined percentages to:
a. The politician who submitted the winning solution.
b. The platform operator.
c. The creator(s) of the applicable post.

6. Offering users the option to vote “non-satisfactory” during the voting period, resetting the voting period for the initiative if a majority selects this option.
